(19) United States
(12) Patent Application Publication
(10) Pub. No.: US 2008/0018951 A1
(43) Pub. Date: Jan. 24, 2008

(54) IMAGE PROCESSING APPARATUS AND CONTROL METHOD THEREOF

(75) Inventor: NOBUYUKI BANNAI, Tokyo (JP)

Correspondence Address: FITZPATRICK CELLA HARPER & SCINTO, 30 ROCKEFELLER PLAZA, NEW YORK, NY, 10112, US

(73) Assignee: Canon Kabushiki Kaisha, Tokyo (JP)

(21) Appl. No.: 11/470,694

(22) Filed: Sep. 7, 2006

(30) Foreign Application Priority Data
Sep. 9, 2005 (JP) 2005-262703

(51) Int. Cl. H04N 1/393

(52) U.S. Cl. 358/451

(57) ABSTRACT

An original area is extracted based on read data, even if a color difference exists slightly between an original sheet and a platen of original plate, or even if CCD is used as a reading sensor of a reading unit. When the extracted original area is a non-rectangular original sheet, it is determined whether or not the original areas overlap each other.

### BACKGROUND OF THE INVENTION

1. Field of the Invention

The present invention relates to an image processing apparatus and a control method thereof, particularly to the image processing apparatus and the control method thereof, in which an image is extracted and read from an original area (or original sheet area) and the read image is retained or printed.

2. Description of the Related Art

In the conventional image processing apparatus, there are proposed many algorithms for detecting and clipping a rectangular area from an original image. There is also known an apparatus which make an overlap determination of the extracted rectangular area.

For example, JP-A No. H08-237537 discloses an image processing apparatus which searches the rectangular area by extracting an outline of an image processing object to search a portion in which the outline forms a straight line. However, in the image processing apparatus disclosed in JP-A No. H08-237537, it is difficult to detect the straight-line portion of the rectangular outline in a noisy environment. It is also difficult that one rectangle is detected while four straight lines are associated to one another. The noise is generated by an unclean original plate, an unclean platen of the original plate, distortion of the original plate, and the like.

In order to improve detection accuracy even in the noisy environment, JP-A No. 2004-030430 discloses an image processing apparatus in which histograms of the numbers of black pixels in a horizontal direction and a vertical direction are produced from binarized original image data and the original image data is approximated by a trapezoid based on the produced histograms. This enables existence and an inclination direction to be detected in the rectangle.

However, in the image processing apparatus disclosed in JP-A No. 2004-030430, it is difficult to detect the original area, when a boundary between the original area and a background is ambiguous, namely, when a color difference exists slightly between an original sheet and the platen of the original plate.

JP-A No. 2004-260457 discloses an image processing apparatus which determines whether or not an object area whose overlapping state of the detected rectangular areas is to be determined has a polygon shape. However, although the image processing apparatus disclosed in JP-A No. 2004-260457 can determine whether or not the rectangular areas are overlapped, the image processing apparatus cannot separate the rectangular areas nor comprehend a size of the overlapped area.

JP-A No. H09-106460 discloses an image processing apparatus which makes a determination of the overlapped areas by imparting different values to pixels of each area. However, in the image processing apparatus disclosed in JP-A No. H09-106460, the number of processing times for imparting the values to the pixels in each area is remarkably increased as each area size and image data resolution are increased, which results in a long processing time.

### SUMMARY OF THE INVENTION

An object of the invention is to provide an image processing apparatus and a production method thereof, in which the original area is easily detected even if the color difference exists slightly between the original sheet and the platen of the original plate.

Another object of the invention is to provide an image processing apparatus and a production method thereof, in which the rectangular area can be separated and the size of the overlapped area can be comprehended.

Still another object of the invention is to provide an image processing apparatus and a production method thereof, in which the processing time is not lengthened even if each area size and the image data resolution are increased.

Further features of the present invention will become apparent from the following description of exemplary embodiments with reference to the attached drawings.

### BRIEF DESCRIPTION OF THE DRAWINGS

FIG. 1 is a block diagram showing an image processing apparatus 100 according to a first embodiment of the invention.

FIG. 2 is a flowchart showing an operation in which the image processing apparatus 100 detects an original area.

FIG. 3 shows an example of a filter used in the first embodiment.

FIG. 4A shows an original image in which end portions of the original sheet are formed by dotted lines, and FIG. 4B shows the original image after the end portions are restored.

FIGS. 5A and 5B show an example in which two original sheets are placed on an original plate and read.

FIGS. 6A and 6B are views explaining an original area detection method.

FIG. 7 is a view explaining a binary image which is of an origin of a label number and a label image.

FIG. 8 is a view explaining the label number and the label image.

FIG. 9 shows an example of a label management table.

FIG. 10 is a view showing a list of original areas which are prospective candidates for one or plural proper original areas to be detected primarily.

FIG. 11 is an explanatory view of the first embodiment.

FIG. 12 is a flowchart showing an operation of the first embodiment.

FIG. 13 is an explanatory view of the first embodiment, and FIG. 13 shows a state in which a rectangular original area P₀P₁P₂P₃ and an original area Q₀Q₁Q₂Q₃ replaced by a rectangle overlap each other.

FIG. 14 shows an example of the label management table.

FIGS. 15A and 15B are explanatory views in a case where an original sheet 1 and an original sheet 2 are overlapped.

FIG. 16 shows an example of an original sheet with a margin.

FIGS. 17A, 17B and 17C show a state in which the original sheet shown in FIG. 16 is internally processed and binarized.

FIG. 18 shows an example of the original sheet in which an area believed to be an original sheet exists.

FIG. 19A shows binary data of the original sheet (name card 41) shown in FIG. 18, and FIG. 19B shows original areas 43, 44 of the original sheet which is of the name card 41.

### DESCRIPTION OF THE EMBODIMENTS

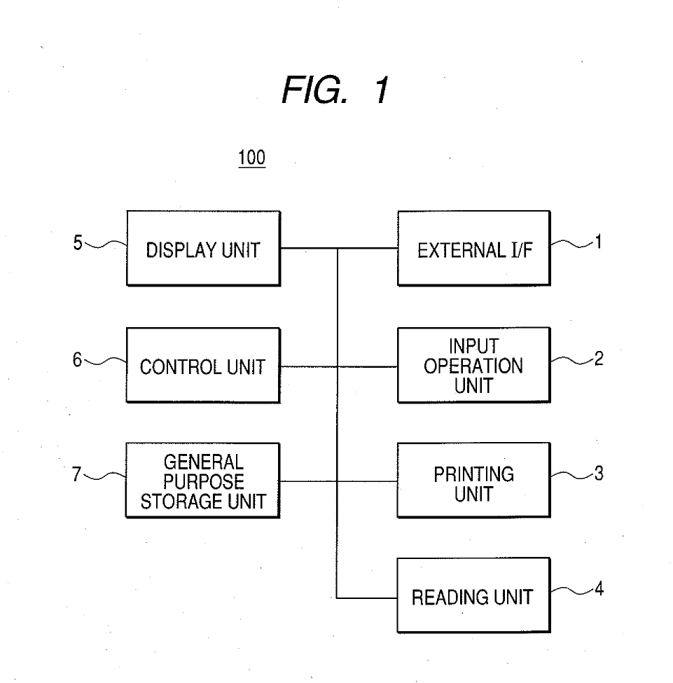

FIG. 1 is a block diagram showing an image processing apparatus 100 according to a first embodiment of the invention.

The image processing apparatus 100 is one which detects an original area (or original sheet area) in original image data. The image processing apparatus 100 includes an external interface unit 1 (external I/F) an input operation unit 2, a printing unit 3, a reading unit 4, a display unit 5, a control unit 6, and a general purpose storage unit 7.

The external interface unit 1 is one through which image data taken by a digital camera is inputted to an apparatus main body. Usually the external interface unit 1 includes slots of various memory cards and a USB connector for connecting the apparatus to the digital camera or PC. A dedicated slot such as a PCMCIA slot which can physically be connected to various memory cards is also provided as a physical acceptance port for the memory card. Data can be transmitted to the image processing apparatus by an IrDA (infrared communication) port as a non-contact interface.

The input operation unit 2 is one by which a user operates the image processing apparatus 100. The printing unit 3 is an inkjet type printer which prints the data from the memory card or PC connected to the external I/F 1 and the image data read by the reading unit 4. There is no limitation to a printing method of the printing unit 3.

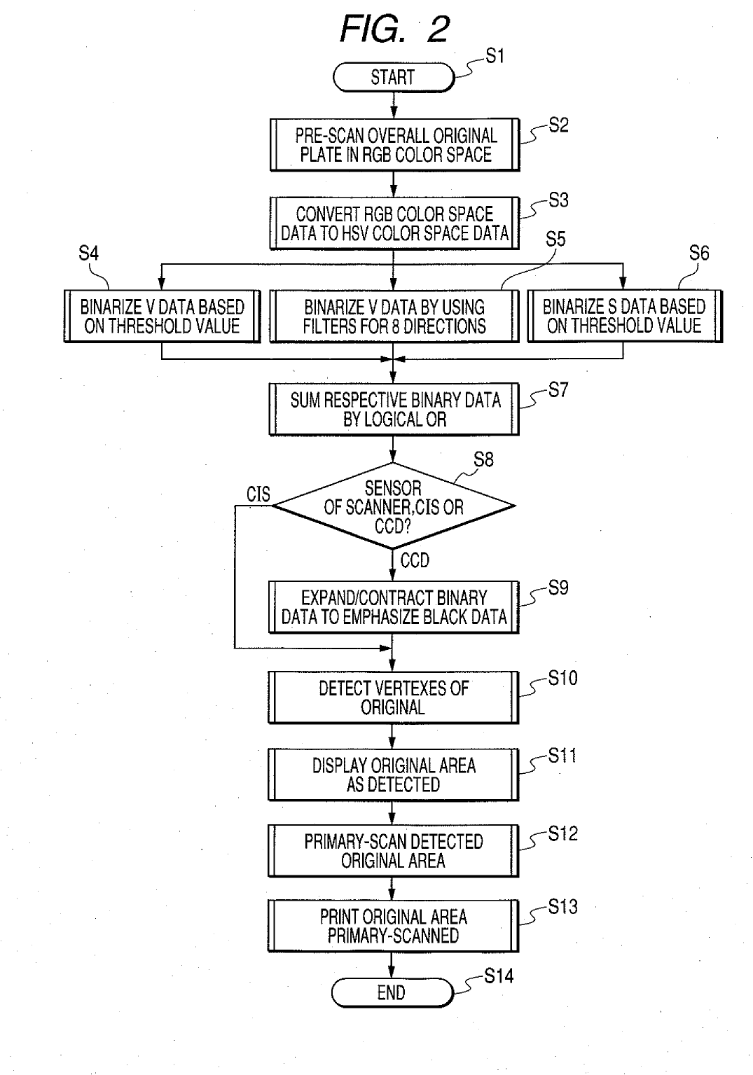

The reading unit 4 is a CCD type or CIS type color scanner which reads a silver-salt photograph and a magazine in the form of the image data (digital data). The display unit 5 displays the read image data, status information on the apparatus, and information inputted by a user through the input operation unit 2. The control unit 6 is one which performs each control procedure of the image processing apparatus 100 and obtains the status of the image processing apparatus 100 from various sensors. The control unit 6 performs an operation of a flowchart shown in FIG. 2.

A program and data for realizing various kinds of control means in the first embodiment are stored in the general purpose storage unit 7, and the general purpose storage unit 7 is also used as a working area for performing the control if needed.

Then, the operation in which the image processing apparatus 100 detects the original area will be described.

FIG. 2 is a flowchart showing an operation in the image processing apparatus 100 detects the original area.

In S1, the image processing apparatus 100 is in a standby state in which the image processing apparatus 100 waits for the operation from a user.

In S2 the image processing apparatus 100 performs pre-scan not with a real color and resolution specified by the user but with RGB color and 75 dpi, in the case where multi-original area automatic detection is required, for example, in the case where the multi-original area automatic detection is specified by user's operation. In this case, the resolution is set at 75 dpi. However, the original sheet may be read with another resolution according to specifications of a reading sensor used in the image processing apparatus 100. In order to realize speed-up of a process of analyzing the original area detection, it is desirable to read the original sheet with a resolution lower than that of later-performed primary scan.

In S3, the data read with RGB color and 75 dpi by the pre-scan in S2 is converted into HSV color space data which is of a color space including information on chroma (or saturation) (S) and information on lightness (or brightness) (V). In this case, the HSV color space is shown as the color space including the information on chroma (S) and the information on lightness (V). However, the color space is not limited to the HSV color space, but the data may be converted into any color space as long as the color space includes the information on chroma (S) and the information on lightness (V). There are many methods of converting the RGB color space into the HSV color space. In the image processing apparatus 100, the following equations are used as transformations of the color space into color difference (H), the chroma (S), and the lightness (V).

$$\begin{matrix}H = ( \begin{matrix}0 & ( in the case of max ( R , G , B ) = min ( R , G , B ) ) \\ ( ( G - B ) / ( max ( R , G , B ) - min ( R , G , B ) ) ) \times 60 & ( in the case of max ( R , G , B ) = R ) \\ ( 2 + ( B - R ) / ( max ( R , G , B ) - min ( R , G , B ) ) ) \times 60 & ( in the case of max ( R , G , B ) = G ) \\ ( 4 + ( R - G ) / ( max ( R , G , B ) - min ( R , G , B ) ) ) \times 60 & ( in the case of max ( R , G , B ) = B )\end{matrix} & ( Formula 1 ) \\ S = ( \begin{matrix}0 & ( in the case of max ( R , G , B ) = min ( R , G , B ) ) \\ ( max ( R , G , B ) - min ( R , G , B ) ) / max ( R , G , B ) & ( in the case of max ( R , G , B ) \neq min ( R , G , B ) )\end{matrix} \\ V = max ( R , G , B ) & ( Formula 2 )\end{matrix}$$

Where max(R, G, B) in the above transformations is a maximum value in each element value and min(R, G, B) is a minimum value in each element value. Scale conversion of each data value is performed such that each data becomes the value in the range of 0 to 255 (integral value).

Then, processes S4 to S6 are concurrently performed.

In S4, lightness component (V) data of the HSV color space data obtained in S3 is binarized based on a threshold value τ to obtain binary data Binary1. The lightness (V) data is set at black (black is indicated by 1 in the following equations) when the lightness (V) data is smaller than the threshold value τ, and the lightness (V) data is set at white (white is indicated by 0 in the following equations) in other cases.

$$Binary 1 = ( \begin{matrix}1 & ( in the case of V < τ ) \\ 0 & ( in the case of V \geq τ )\end{matrix} \qquad ( Formula 3 )$$

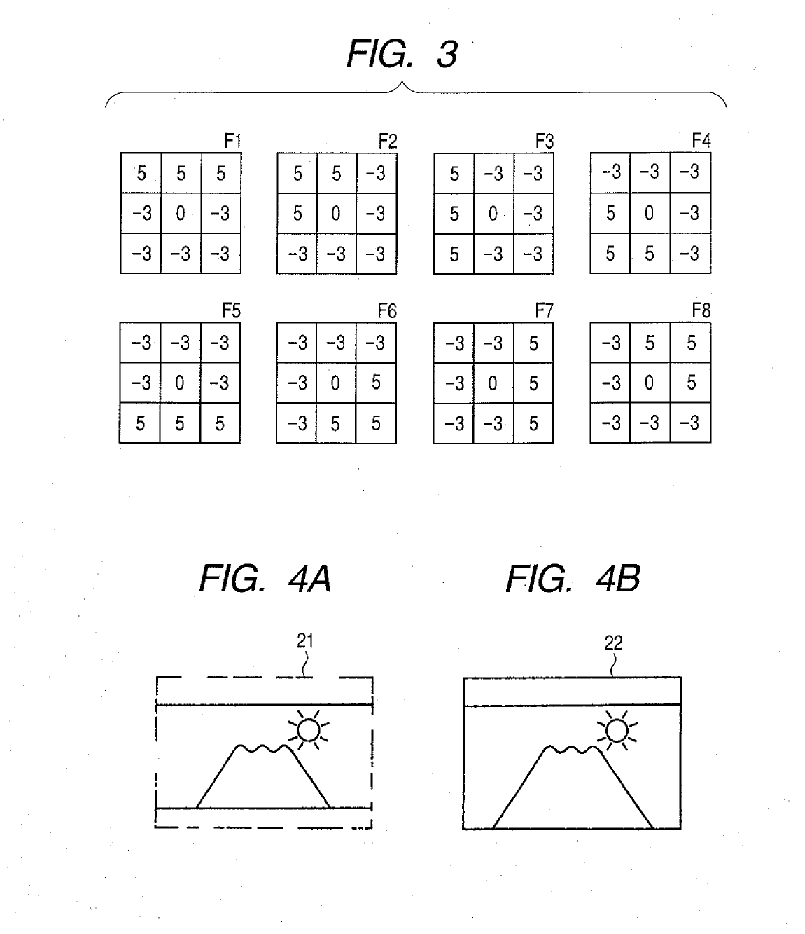

FIG. 3 shows an example of a filter used in the first embodiment.

In S5, the lightness component (V) data of the HSV color space data obtained in S3 is divided in each three-by-three window. Similarly to S4, the binarizing process is performed with the threshold value τ to values obtained by multiplying with eight Kirsch edge detection filters F1 to F8 shown in FIG. 3 respectively so as to obtain binary data Binary2ᵢ (where i=1 to 8).

The filters F1 to F8 shown in FIG. 3 are filters (3×3 matrices) which are used to detect an edge from above, obliquely upper left, left, obliquely lower left, below, obliquely lower right, right, and obliquely upper right respectively. The binary data Binay2ᵢ (where i=1 to 8) are obtained by multiplying with each of the filters F1 to F8 and then execution of threshold value process. The obtained binary data Binary2ᵢ (where i=1 to 8) are summed by logical addition computation to obtain binary data Binary2 including all the edge information on the eight directions by logical addition computation.

$$Binary 2 i = ( \begin{matrix}1 & ( in the case of V < τ ) \\ 0 & ( in the case of V \geq τ )\end{matrix} \\ Binary 2 = Binary 21 ⋃ Binary 22 ⋃ Binary 23 ⋃ Binary 24 ⋃ Binary 25 ⋃ Binary 26 ⋃ Binary 27 ⋃ Binary 28 \\ where i = 1 to 8 , \qquad ( Formula 4 )$$

Although the Kirsch filter is used as the edge detection filter in the first embodiment, other typical edge detection filter and modified filters thereof may be used. The divided window size is not limited to three by three, and the shape of the filter is changed in accordance with the divided window size.

In S6, chroma component (S) data of the HSV color space data obtained in S3 is binarized based on a threshold value K to obtain binary data Binary3. The chroma (S) data is set at black (1) when the chroma (S) data is smaller than the threshold value K, and the chroma (S) data is set at white (0) in other cases.

$$Binary 3 = ( \begin{matrix}1 & ( in the case of S < κ ) \\ 0 & ( in the case of S \geq κ )\end{matrix} \qquad ( Formula 5 )$$

In S7, the binary data Binary1 to Binary3 obtained in S4 to S6 are summed by the logical addition computation to determine final binary data Binary.

Binary=Binary1∪Binary2∪Binary3

In S8, it is distinguished whether a type of the reading sensor incorporated into the image processing apparatus 100 is CCD or CIS based on the information from the control unit 6.

When the reading sensor mounted on the apparatus is the CIS type, a light quantity of a light source is not so large due to an illumination system structure of the reading sensor, a shadow easily emerges at a single portion of the original sheet, and the edge of the original sheet is easily detected. Therefore, the flow goes to S10 without performing any process.

On the other hand, when the reading sensor mounted on the apparatus is the CCD type, because the light quantity of the light source is large due to an optical structure of the reading sensor, the shadow hardly emerges at the single portion of the original sheet, and it is difficult to detect the end portion of the original sheet as the straight line. In this case, the straight line is frequently discontinued as a dotted line. Accordingly, when the flow transfers directly to the process of detecting the original area from the final binary data Binary obtained in S7, it is difficult to correctly detect the original area.

Therefore, when the reading sensor is the CCD type, in S9, an expansion process and contraction process of the black pixel data are continuously performed plural times to the binary data Binary obtained in S7, which restore the discontinued end portion of the original sheet to correctly detect the original area.

The expansion process is one, in which the binary data Binary is divided in each three-by-three window, and a center pixel of the window is set at a black pixel (1) when at least one black pixel (1) exists in the window. The contraction process is one in which the center pixel of the window is set at a white pixel (0) when at least one white pixel (0) exists in the window. The window may be formed by other sizes except for three by three.

FIG. 4A shows the original sheet image in which end portions of the original sheet are formed by dotted lines, and FIG. 4B shows the original sheet image after the end portions are restored.

FIG. 4A shows a discontinuous original sheet image 21 in which the end portions of the original sheet are formed by the dotted lines. The original sheet image 21 whose end portions are discontinued is an example in which data obtained by the CCD reading sensor is binarized to form the binary data Binary.

FIG. 4B shows an original sheet image 22 after the end portions are restored by continuously performing the expansion process and contraction process of the black pixel data plural times.

In S10, each vertex position of the original sheet is detected from the binary data Binary. When the vertices of the original sheet are detected in S10, it is assumed that the original sheet is a rectangular original sheet, and it is also assumed that the original sheet is inclined. Then, the vertices of the original sheet are detected as follows.

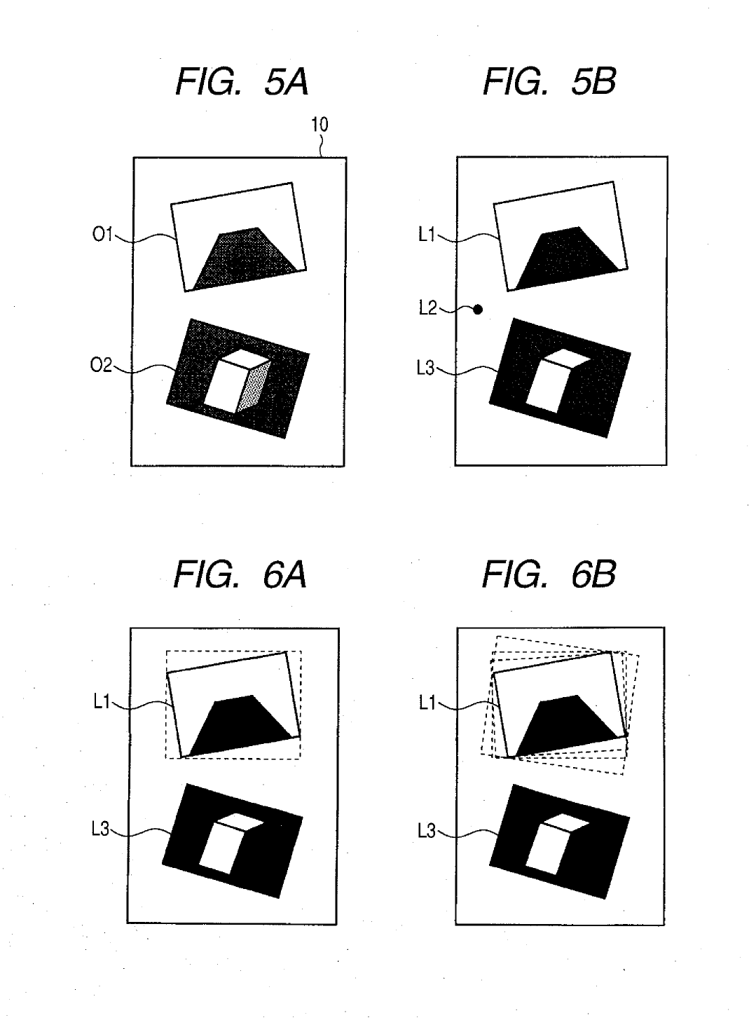

FIGS. 5A and 5B show an example in which the two original sheets are placed on the original plate and read.

For the purpose of explanation of S10, FIG. 5A shows an example in which original sheets 01 and 02 are placed on the original plate 10 and read. FIG. 58 shows the image data in which the image is binarized through processes S2 to S9. In S10, a label number is imparted to the image having the continued black pixels in the images shown in FIG. 5B. At this point, the same label number is imparted to each of the pixels in the continued black pixels. A block of the black pixels to which the same label number is imparted is called as a label image. In FIG. 5B, the reference numerals L1 to L3 denote label images.

Then, a histogram of the number of pixels is produced in each label image, and the label image having the number of pixels not more than a predetermined number is eliminated as the noise from the next process and all the processes that follow the next process. In FIG. 5B, the reference numeral L2 denotes a noise.

Then, a method of extracting the original area will be described.

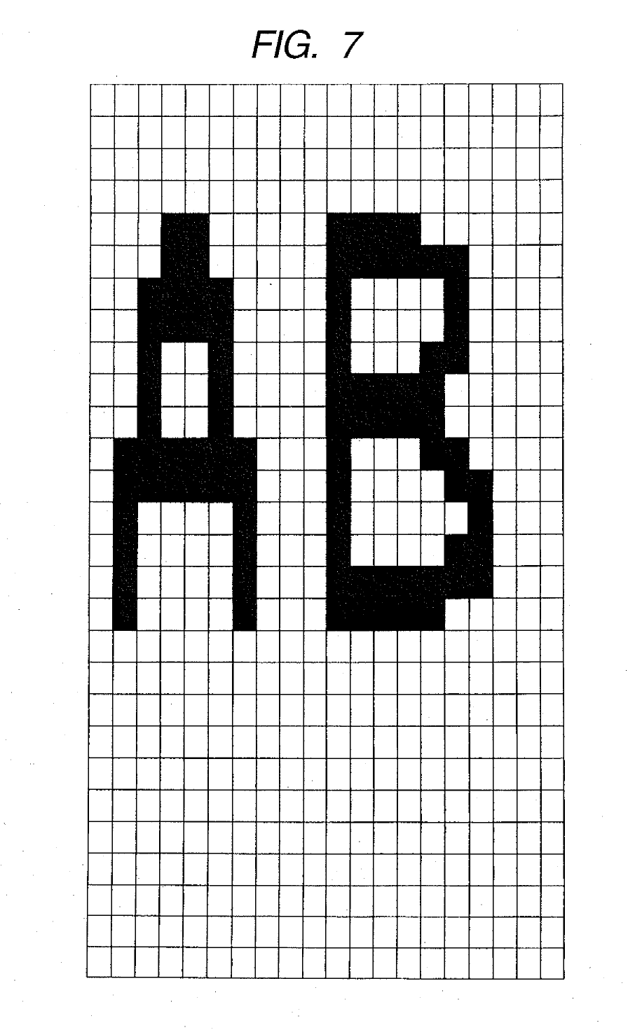

FIGS. 6A and 6B are views explaining the original area detection method.

A position of a rectangle is set such that each side of the rectangle shown by the dotted line in FIG. 6A comes into contact with the label image L1. As shown in FIG. 6B, the position of the rectangle is set such that each side of the rectangle comes into contact with the label image L1 by changing an inclination angle of the rectangle in limited amounts. Then, areas of the rectangles whose inclination angle are changed in limited amounts are compared to one another. It is determined that the image having the smallest rectangular area corresponds to the original image, and the vertex positions and inclination angle of the rectangle are stored as the original area in the general purpose storage unit 7.

Then, the original area detection is performed to all the label images. In the example shown in FIG. 6B, because the label image L2 is eliminated as the noise, the original area detection is performed to the label image L3 subsequent to the label image L1.

The label number and the label image will be described below.

FIG. 7 shows the binary image data.

Characters of “AB” are written in FIG. 7.

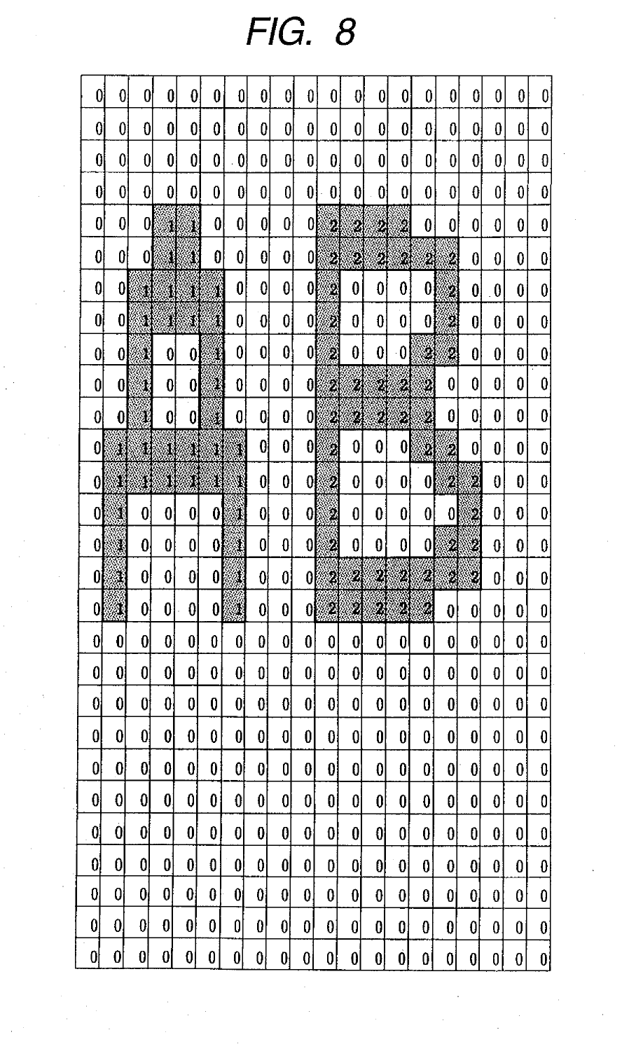

FIG. 8 shows a management table by which the label number is managed.

In the label number management table, one number space exists in each pixel of the image data, and the number space is provided corresponding to the same position as the position of each pixel.

In FIG. 8, a label number 1 is imparted to the binary image data of a character “A”, and a label number 2 is imparted to the binary image data of a character “B”. In FIG. 8, in order to easily recognize that the position of the number space is located at the same position as the pixel position, the number spaces corresponding to the pixel positions of the characters “A” and “B” is colored in gray (displayed by halftone dots).

The label number management table shown in FIG. 8 is stored in the general purpose storage unit 7, and the label number management table is updated by the control unit 6. In the label number management table, all the number spaces are filled in with “0” at an initialized state. In the case where the label is imparted, the initial value of “0” in each number space is updated by the label number.

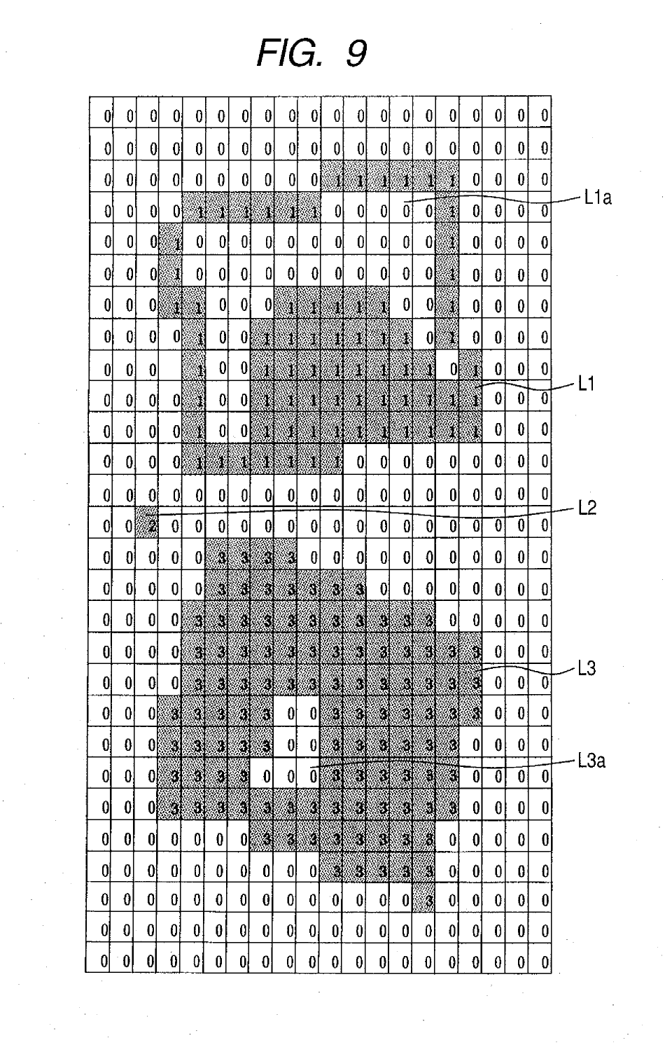

FIG. 9 shows the label management table of the image data shown in FIG. 5B as an example in the case where the actual photograph image is read. In FIG. 9, the reference numerals L1, L2, and L3 (gray portions) denote the label image, and the reference numerals L1d and L3d denote a blank area.

In S11, the detected original area is displayed. At this point, the original area detected in S10 is not always one area.

FIG. 10 is a view showing a list of original areas which are prospective candidates for one or plural proper original areas to be detected primarily.

The detected original area is stored in the list shown in FIG. 10.

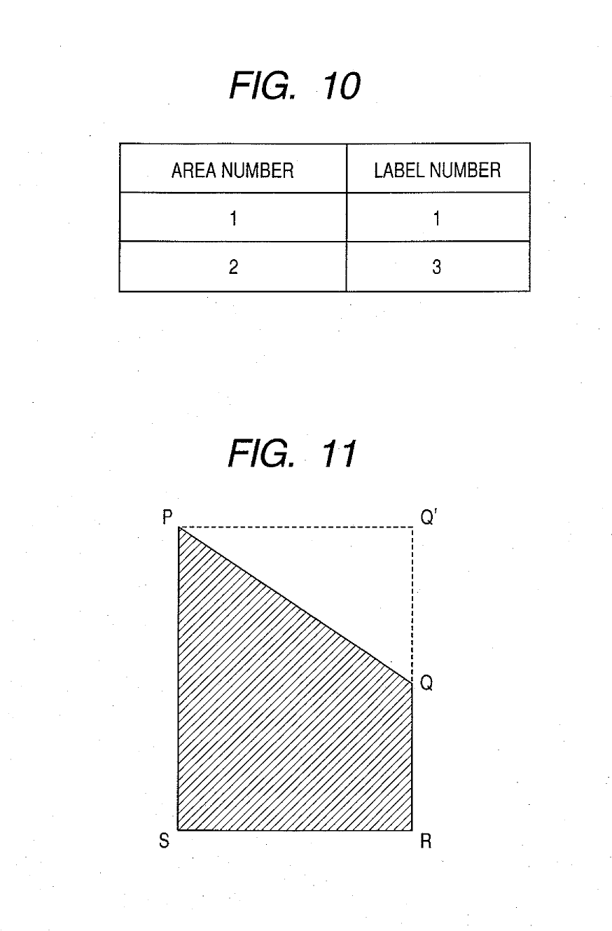

FIG. 11 is an explanatory view of the first embodiment.

When the original sheet is formed not in the square angle having four right angles but in a trapezoid PQRS shown in FIG. 11, coordinates of the detected vertices are compared to one another to replace the trapezoid PQRS by a rectangle PQ′RS. Thus, the minimum rectangular area PQ′RS including the original sheet is detected as the original area.

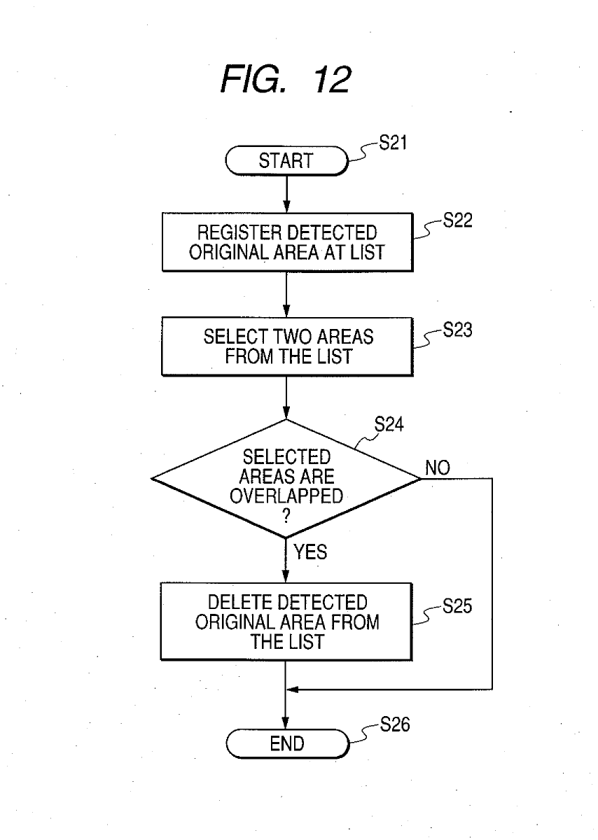

FIG. 12 is a flowchart showing an operation of the first embodiment.

In S22, the detected original area is registered in the list. In S23, two original areas are selected from the list in which the detected original area is registered. In S24, it is determined whether or not the two selected original areas overlap each other. When the two selected original areas overlap each other, the detected original areas are deleted from the list in S25, and the flow is ended (S26).

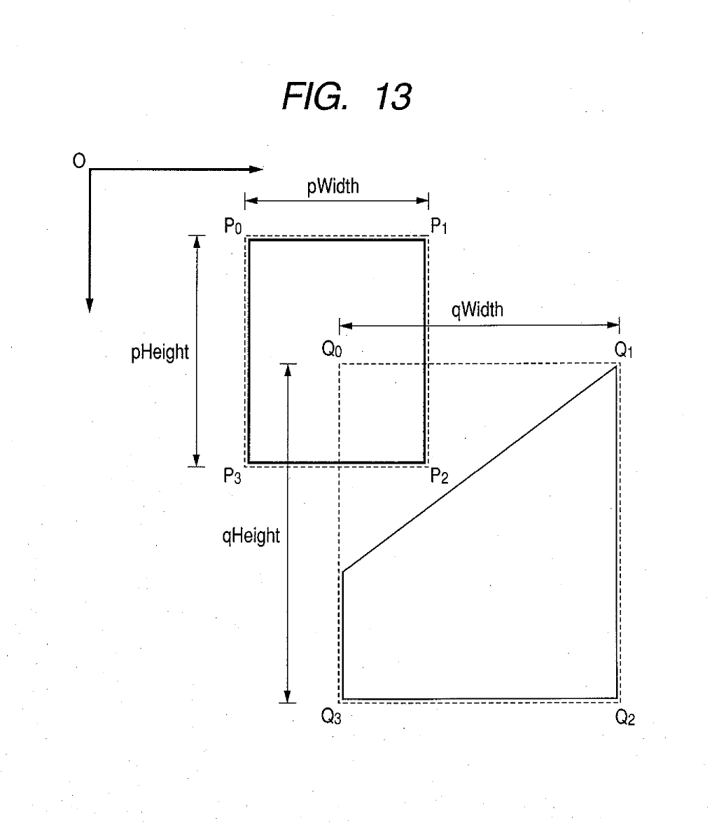

FIG. 13 is an explanatory view of the first embodiment, and FIG. 13 shows a state in which a rectangular original area P₀P₁P₂P₃ and an original area Q₀Q₁Q₂Q₃ replaced by the rectangle overlap each other.

It is assumed that the rectangular original area P₀P₁P₂P₃ and the original area Q₀Q₁Q₂Q₃ replaced by the rectangle are detected as shown in FIG. 13.

First the rectangular original sheet P₀P₁P₂P₃ is set at a basic original sheet, and the original area original sheet Q₀Q₁Q₂Q₃ replaced by the rectangle is set at a reference original sheet. A width (pWidth, qWidth) and a height (pHeight, qHeight) of each original sheet are determined. The width and height of the original sheet can easily be determined by using the following distance between two points (for example, P₀ (x₀,y₀) and P₁ (x₁,y₁)).

(Formula 6)
p̅₀̅p̅₁̅=\sqrt{(x₁−x₀)²+(y₁−y₀)²}

Then, equations of straight lines 1₀ to 1₃ passing through two vertices P₀ and P₁, P₁ and P₂, P₂ and P₃, and P₃ and P₀ of the original sheet P₀P₁P₂P₃ respectively are determined. The equation of the straight line passing through the two points P₀(x₀,y₀) and P₁ (x₁,y₁) can be determined by utilizing the following formula.

$$\frac{x - {x}_{0}}{{x}_{1} - {x}_{0}} = \frac{y - {y}_{0}}{{y}_{1} - {y}_{0}} \qquad ( Formula 7 )$$

Then, lengths dₙ₀ to dₙ₃ of perpendiculars from vertices Qₙ (n is 0 to 3) of the original area Q₀Q₁Q₂Q₃ to the straight lines straight lines 1₀ to 1₃ are determined.

The lengths d of the perpendicular from the point P₀(x₀,y₀) to a straight line ax+by+c=0 can be determined by utilizing the following formula.

$$d = \frac{\vert a {x}_{0} + b {y}_{0} + c \vert}{\sqrt{{a}^{2} + {b}^{2}}} \qquad ( Formula 8 )$$

A sum dₙ₀+dₙ₂ of the lengths of the perpendiculars and the height pHeight of the original area P₀P₁P₂P₃ are compared to each other, and a sum dₙ₁+dₙ₃ of the lengths of the perpendiculars and the width pWidth of the original area P₀P₁P₂P₃ are compared to each other. In the case of dₙ₀+dₙ₂≦pHeight and dₙ₁+dₙ₃≦pWidth, it is found that the vertices Qₙ of the original sheet Q₀Q₁Q₂Q₃ are located on the original area P₀P₁P₂P₃. That is, the original area P₀P₁P₂P₃ and the original area Q₀Q₁Q₂Q₃ overlap each other.

When the original sheet areas overlap each other, both the overlapped original sheet areas are deleted from the list shown in FIG. 10. In the case of dₙ₀+dₙ₂>pHeight or dₙ₁+dₙ₃>pWidth, it is possible that the original area P₀P₁P₂P₃ and the original area Q₀Q₁Q₂Q₃ do not overlap each other. When the overlap determination is made for all the vertices, the next two original areas are selected from the list. Then, the basic original sheet is set at the original area P₀P₁P₂P₃, the reference original sheet is set at the original area Q₀Q₁Q₂Q₃, and the overlap determination is similarly made. Thus, the determination whether or not the original areas overlap each other is made for all the original areas registered in the list.

In S12, the primary scan is performed only to the determined original area. Then, the flow goes to S13, the original area data to which the primary scan is performed is printed, and the flow is ended.

In the above description, when the original areas overlap each other, both the original areas are deleted from the list. However, in the case of the overlap shown in FIG. 13, as a result of the overlap determination, it is determined that the areas overlap each other in the original area Q₀Q₁Q₂Q₃ and original area P₀P₁P₂P₃. Therefore, it can be determined that a part of one of the areas invades into the other area. Accordingly, only the original area (area Q₀Q₁Q₂Q₃ in FIG. 13) into which a part of the original area invades may be eliminated while the other original area (area P₀P₁P₂P₃ in FIG. 13) is extracted.

That is, when the original sheets detected as the original area overlap each other, it is possible that one of the original areas is not extracted as the original area.

Specifically, the following determination is performed.

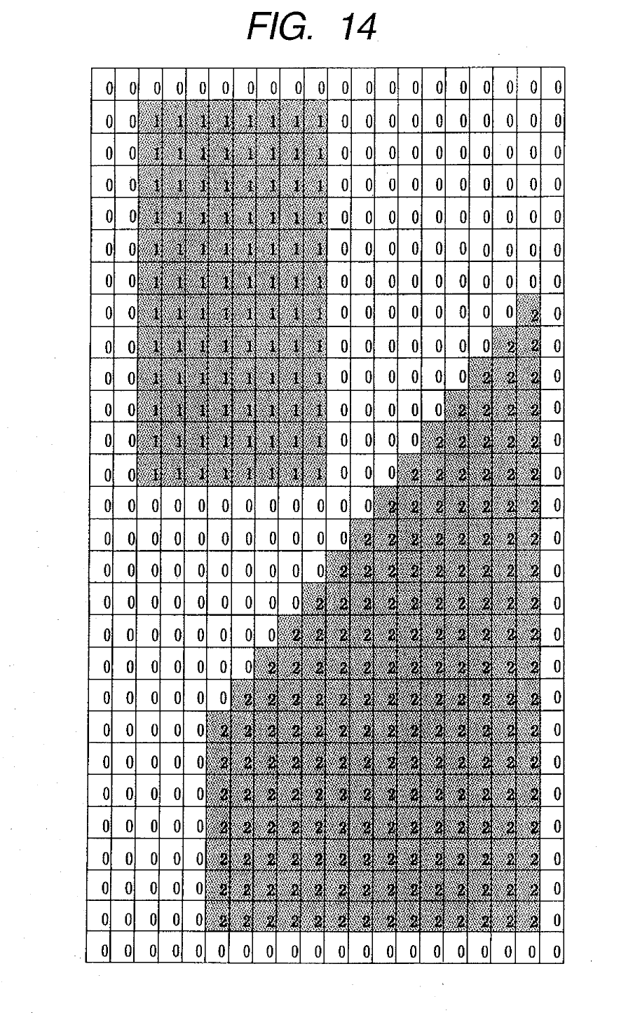

FIG. 14 shows the label management table corresponding to the image shown in FIG. 13 as an example of the label management table.

When it is determined through the processes shown in FIG. 12 that a label image 1 to which a label 1 is imparted and a label image 2 to which a label 2 is imparted overlap each other, a ratio 1 of the number of pixels of the label image 1 to the number of pixels corresponding to the area of the area P₀P₁P₂P₃ is determined. Similarly, a ratio 2 of the number of pixels of the label image 1 to the number of pixels corresponding to the area of the area Q₀Q₁Q₂Q₃ is determined. When the ratios are close to 1, the difference in area between the label image and the rectangular area (area P₀P₁P₂P₃, area Q₀Q₁Q₂Q₃) shown in FIG. 13 is small, and it can be determined that the label image is close to the rectangle. On the other hand, when the ratios are small, it can be determined that the shape of the label image is not the rectangle. Therefore, the ratio 1 and the ratio 2 are compared to each other, it is determined that the label image having the ratio closer to 1 is the rectangular image, and it is determined that the label image having the lower ratio is the original area (area Q₀Q₁Q₂Q₃ in FIG. 13) into which a part of the original area invades.

When both the ratio 1 and the ratio 2 are not more than a predetermined value which is lower than 1, it is determined that both the label images are not the rectangular image. In this case, because it cannot be determined whether or not one of the rectangular images invades into the other rectangular image, both the rectangular images are eliminated from the list.

As shown in FIG. 9, a white area exists between the label images, and the number of pixels of the label is possibly decreased. Therefore, in determining the ratios, the number of pixels of the blank area located in the label image may be added to the number of pixels of the label image, which prevents the number of pixels of the label image from being decreased. Therefore, the determination that the label image is not the rectangle, due to the decrease in ratio, can be prevented.

Then, the case where a user intentionally overlaps the plural original sheet will be described.

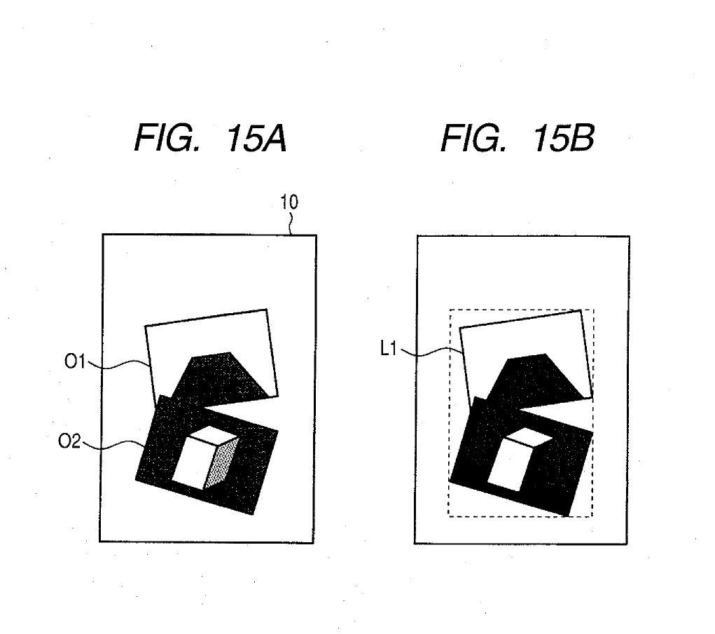

FIGS. 15A and 15B are explanatory views in a case where an original sheet 1 and an original sheet 2 are overlapped.

When the original sheet 1 and the original sheet 2 are overlapped as shown in FIG. 15A, the pixels of the original sheet 1 and the pixels of the original sheet 2 become continued as shown in FIG. 15B, so that the continued pixels become one block.

Accordingly, the label image becomes one, and it is determined that the original sheet is one. In this case, it is determined that the original area is a rectangle shown by the dotted line of FIG. 15B.

In the first embodiment, when the extracted original sheet is the trapezoidal original sheet, the rectangular area including the original sheet is recognized as the original area. Alternatively, when the extracted original sheet is the original sheet having a triangle, a circle, an ellipse, or the like, namely the extracted original sheet is the non-rectangular original sheet, the rectangular area including the original sheet is recognized as the original area.

### Second Embodiment

In a second embodiment of the present invention, when the detected original areas overlap each other, it is determined that the original areas are not the original area to which the primary scan should be performed, by eliminating the original areas from the list.

By changing the process as shown below, both the original areas in which the mutually overlapped areas are eliminated can be treated as the proper original area.

For example, in the case where it is determined that the original area P₀P₁P₂P₃ and the original area Q₀Q₁Q₂Q₃ overlap each other as shown in FIG. 13, and both the original areas are extracted a part of the original area P₀P₁P₂P₃ invades into the original area Q₀Q₁Q₂Q₃. However, as described in the first embodiment, because it is already known which vertex of the original area overlaps the other original area, the overlapped area on the original area Q₀Q₁Q₂Q₃ can be derived. As with the first embodiment, the original area which invades into the other original area and the original area into which the other original area invades are distinguished from each other based on the ratio between the number of pixels corresponding to the rectangular area whose each side is in contact with the label image and the number of pixels of the label image.

In FIG. 13, assuming that the coordinates of the vertices P₁, P₂, and P₃ are ser at (xₚ₁,yₚ₁), (xₚ₂,yₚ₂), and (xₚ₃,yₚ₃) respectively and the coordinate of the vertex Q₀ is set at (x_{q0},y_{q0}), the overlapped area becomes the following ranges.
X_{q0}<=x<=xₘₐₓ
Y_{q0}<=y<=yₘₐₓ

Where Xₘₐₓ=max([Xₚ₁Xₚ₂Xₚ₃X_{q0}]) and yₘₐₓ=max([yₚ₁yₚ₂yₚ₃y_{q0}]). The original area in which a part of the other invading original sheet is eliminated, can be extracted by coloring the overlapped area in white or the like.

Thus, when the original sheets which are detected as the original area overlap each other, the area into which the other image invades can be eliminated from the image into which the other image invades.

According to the second embodiment, in the case where the two original sheets are detected, for example, in the case where one of the original sheets is the rectangle while the other original sheet is the trapezoid and the trapezoidal original sheet exists near the rectangular original sheet at the same time, the processes of the original sheets do not become abnormal by the relative position between the rectangular original sheet and the trapezoidal original sheet. In addition, the term of “abnormal” shall means that an error is generated by the overlap determination and the primary scan cannot be performed.

### Third Embodiment

In a third embodiment of the present invention, in the case where the one of the two original sheets is completely included in the other original sheet, or in the case where the two original sheets partly overlap each other, each two sides of the original sheets are compared. When both the lengths of the two sides in the smaller original sheet are not lower than 70% of the lengths of the two sheets in the larger original sheet, the smaller original sheet is left while the larger original sheet is eliminated.

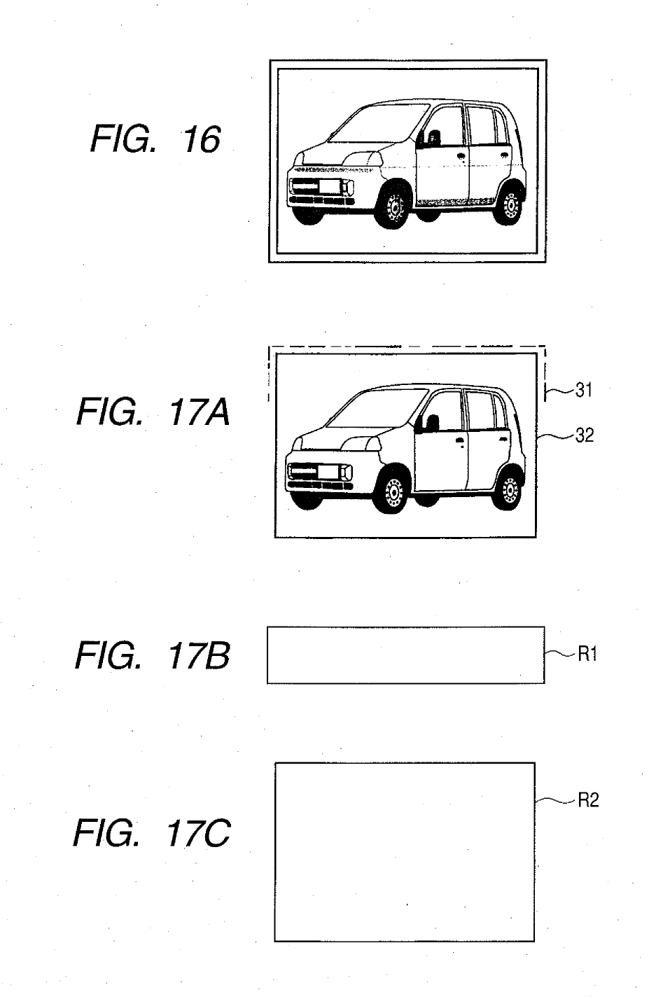

FIG. 16 shows an example of an original sheet with a margin or fringe.

When an original sheet with a margin shown in FIG. 16 is read, sometimes the edge in the margin portion is not clearly caught. In the determination of the original sheet with the margin, although the one original sheet with the margin is read, sometimes it is wrongly determined that the two original sheets overlap each other, which results in the failure in the extraction of the original area.

FIGS. 17A, 17B and 17C show a state in which the original sheet shown in FIG. 16 is internally processed and binarized.

FIG. 17A shows the state in which the original sheet shown in FIG. 16 is internally processed and binarized. In FIG. 17A, the edge of the margin is not clearly caught. In FIG. 17A, the reference numeral 31 denotes an outer edge of the margin, and the reference numeral 32 denotes an inner edge of the margin. Accordingly, the one original sheet with the margin is wrongly recognized as two original sheets of a rectangular area R1 shown in FIG. 17B and a rectangular area R2 shown in FIG. 17C. In this case, when the algorithm of the first embodiment is used, both the original sheets are eliminated.

However, in the process of the third embodiment, the rectangular area R2 shown in FIG. 17C, i.e., the marginless original area is clearly extracted.

That is, in the case where the two original sheets partly overlap each other, the lengths of the two sides of the original sheets are compared. When the lengths of the two sides in the smaller original sheets are not lower than 70% of the lengths of the two sides in the larger original sheet, the smaller original sheet is left while the larger original sheet is eliminated. Therefore, the marginless original area is clearly extracted.

In the third embodiment, in the case where the two original sheets partly overlap each other, the lengths of the two sides of the original sheets are compared. When the lengths of the two sides in the smaller original sheets are not lower than 70% of the lengths of the two sides in the larger original sheet, the smaller original sheet is left while the larger original sheet is eliminated. Instead of 70%, a predetermined ratio may be used.

In the third embodiment, in the case where the two original sheets partly overlap each other, the areas of the original sheets are compared. When the area of the smaller original sheet is not lower than a predetermined ratio of the area of the larger original sheet, the original sheet having the smaller area may be left while the original sheet having the larger area is eliminated.

Only the case in which the edge of the margin portion is not clearly caught when the original sheet with the margin is read has been described in the above. But, sometimes the edge of the margin portion can clearly be caught. In this case, the two original sheets of the original area with the margin and the marginless original area are detected, and one (detected marginless original area) of the two original sheets is completely included in the other original sheet (detected original area with margin). In this case, the marginless original area can be extracted by performing the process as described above.

### Fourth Embodiment

In a fourth embodiment of the present invention, in the case where the two original sheets completely overlap each other, the lengths of the two sides of the original sheets are compared. When the lengths of the two sides in the smaller original sheets are lower than 70% of the lengths of the two sides in the larger original sheet, the larger original sheet is left while the smaller original sheet is eliminated. In this case, it is necessary to confirm that the two original sheets completely overlap each other, namely the small original sheet is completely included in the larger original sheet.

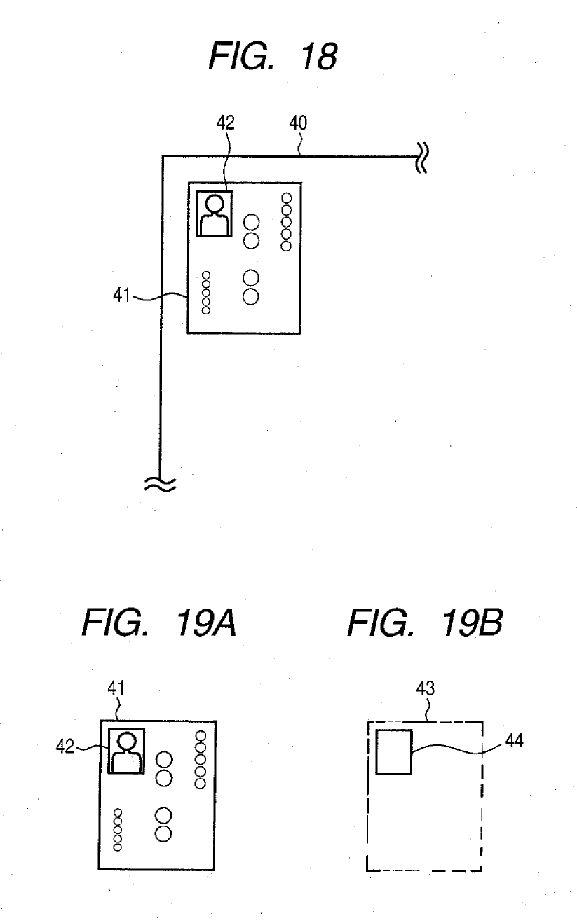

FIG. 18 shows an example of the original sheet in which an area believed to be an original sheet exists.

For example, in the case where a photograph 42 exists in the original sheet which is of a name card 41, there is a possibility that the photograph 42 is recognized as another original sheet different from the original sheet which is of the name card 41. In FIG. 18, the reference numeral 40 denotes an original plate.

FIG. 19A shows binary data of the original sheet (name card 41) shown in FIG. 18, and FIG. 19B shows original areas 43 and 44 extracted from the original sheet which is of the name card 41.

FIG. 19A shows the binary data of the original sheet which is of the name card 41 shown in FIG. 18. FIG. 19B shows original areas 43 and 44 extracted from the original sheet which is of the name card 41. The original area 43 is an outer periphery of the name card 41, and the original area 44 is an outer periphery of the photograph 43 printed in the name card 41. Because FIG. 19B shows only the original area, image contents (such as characters, graphics, and a person which are printed in the name card) shown in FIG. 19A are not displayed.

The two original areas of the outer rectangular portion (original area 43) of FIG. 19B and the inner rectangular portion (original area 44) of FIG. 19B are extracted.

When only the inner original sheet is simply left, the original sheet contents (such as characters, graphics, and a person which are printed in the name card 41) which should be left cannot be extracted. Therefore, in the case where the two original sheets completely overlap each other, the lengths of the two sides of the original sheets are compared. When the lengths of the two sides in the smaller original sheets are lower than 70% of the lengths of the two sides in the larger original sheet, the larger original sheet is left while the smaller original sheet is eliminated. Thus, by leaving the larger original sheet, the primary scan can be performed to the larger original area to read the overall area of the original sheet such as the name card in which the characters, the graphics, and the personal photograph are printed.

In the fourth embodiment, in the case where the two original sheets completely overlap each other, the lengths of the two sides of the original sheets are compared. When the lengths of the two sides in the smaller original sheets are lower than 70% of the lengths of the two sides in the larger original sheet, the larger original sheet is left while the smaller original sheet is eliminated. Instead of 70%, a predetermined ratio may be used.

In the fourth embodiment, in the case where the two original sheets completely overlap each other, the areas of the original sheets are compared. When the area of the smaller original sheet is lower than a predetermined ratio of the area of the larger original sheet, the original sheet having the smaller area may be left while the original sheet having the larger area is eliminated.

According to the invention, when the plural original areas extracted from the image read by the image processing apparatus overlap each other, both the original areas or one of the original areas is neglected to the original areas overlapping one another, which allows the extraction of the plural original sheets to be prevented while the plural original sheets overlap one another.

According to the invention, the area where the original sheets overlap each other is processed, so that both the original areas overlapping each other can be extracted.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2005-262703, filed Sep. 9, 2005, which is hereby incorporated by reference herein in its entirety.

What is claimed is:

1. An image processing apparatus which extracts an original area, comprising:
reading means for reading an original sheet;
extraction means for extracting the original area based on reading data outputted by the reading means;
and
determination means for determining whether or not the plurality of original areas extracted by the extraction means overlap one another.

2. An image processing apparatus according to claim 1,
including notification means for notifying a user that the plurality of original areas overlap one another when the determination means determines that the plurality of original areas overlap one another.

3. An image processing apparatus according to claim 1,
comprising deletion means for deleting the original area having a smaller area in the plurality of overlapped original areas when the determination means determines that the plurality of original areas overlap one another.

4. An image processing apparatus according to claim 1,
comprising deletion means for deleting a first original area in the case where a second original area does not run over from the first original area and, at the same time, in the case where a ratio of an area of the second original sheet to an area of the first original area is not lower than a predetermined value, when the determination means determines that the second original area overlaps the first original area.

5. An image processing apparatus according to claim 1,
comprising retaining means for retaining one or a plurality of original areas extracted by the extraction means as an effective original area.

6. An image processing apparatus according to claim 1, comprising recognition means for recognizing a rectangular area including the original sheet as the original area when the original sheet extracted by the extraction means is a non-rectangular original sheet.

7. An image processing apparatus according to claim 6,
wherein the recognition means is one which does not recognize one of the plural original areas as the original area when the determination means determines that the plurality of original areas overlap one another.

8. An image processing apparatus according to claim 1,
comprising processing means for processing the overlap area of the original sheets, wherein the processing means eliminates the overlap area from the original areas and performs extraction as the plural original areas when the determination means determines that the original areas overlap each other.

9. A method of controlling an image processing apparatus which extracts an original area, comprising the steps of:
reading an original sheet;
extracting the original area based on reading data outputted in the reading step;
and
determining whether or not the plurality of original areas, extracted in the extracting step, overlap one another.

10. A method of controlling an image processing apparatus according to claim 9, comprising step of recognizing a rectangular area including the original sheet as the original area when the original sheet extracted in the extracting step is a non-rectangular original sheet.
